(19) United States
(12) Patent Application Publication
(10) Pub. No.: US 2005/0183741 A1
(43) Pub. Date: Aug. 25, 2005

(54) Methods of cleaning and cutting using jetted fluids

(76) Inventors: Jim B. Surjaatmadja, Duncan, OK (US); Bradley L. Todd, Duncan, OK (US)

Correspondence Address: Robert A. Kent;Halliburton Energy Services, 2600 South 2nd Street, Duncan, OK, 73536-0440, US

(21) Appl. No.: 10/783,207

(22) Filed: Feb. 20, 2004

(51) Int. Cl. B08B 3/02

(52) U.S. Cl. 134/6; 134/34; 134/36

(57) ABSTRACT

Methods of cleaning a surface comprising the step of jetting against a surface to be cleaned, a cleaning fluid comprising a liquid base fluid and degradable particles wherein the degradable particles act as an abrasive agent.

### BACKGROUND

The present invention relates to methods of using jetted fluids. More specifically, the present invention relates to methods of using jetted fluids comprising degradable particles in cleaning and cutting operations.

Jetted fluids have been used in cleaning operations wherein a fluid may be jetted against a surface to be cleaned. Jetted fluids may be used for cleaning a wide variety of surfaces including, but not limited to, metal, glass, and ceramic surfaces. For example, jetted fluids may be used in industrial applications to remove paint or to clean steam pipes, boilers, and the like. A wide variety of fluids have been used in such cleaning operations. For example, water may be jetted against a surface under pressure to effect cleaning. However, such cleaning applications using water alone often require the use of high jetting pressures, often as high as 25,000 psi or higher. To accomplish adequate cleaning with lower pressures, chemical cleaning agents may be added to the water. One commonly used chemical cleaning agent is a chlorinated solvent. Water comprising a chlorinated solvent may be able to achieve adequate cleaning a greatly reduced pressures compared to water alone (e.g., 1,000 or 2,000 psi). However, the use of such chemical cleaning agents may be environmentally undesirable. In particular, regulations may require the capture of chemical cleaning agents so that they are not permanently released to the environment.

An alternative to chemical cleaning agents is to add a solid material to the fluid being jetted that acts as an abrasive cleaning agent. While such abrasive cleaning agents can improve the cleaning ability of jetted fluids, they may become undesirable solid waste material that must be disposed of as the job progresses. In some instances, such as where a jetted fluid is used to clean the inside of a vessel or some other enclosed space, the extra cost associated with removing the abrasive cleaning agent may so offset the increased cleaning efficiency as to make its use impractical. Also, where the jetted fluid is used in an environmentally sensitive location, the abrasive cleaning agent used may need to be removed to restore the cleaned location after the jetting treatment is complete.

In addition to their use in cleaning surfaces, jetted fluids have also been used to cut surfaces. For example, jetted fluids have been used to cut rock, slabs, steel plates, and engraving materials (e.g., steel or granite). In such methods, the jetted fluids often incorporate abrasive particles to aid in the cutting. One cutting use of jetted fluids in the oil field services industry is often referred to as “hydrajetting,” in which fluids comprising particles may be jetted into a formation to stimulate hydrocarbon production. Hydrajetting involves the use of hydraulic jets, inter alia, to increase the permeability and production capabilities of a formation. In a common hydrajetting operation, a hydrajetting tool having at least one fluid jet-forming nozzle is positioned adjacent to a formation to be fractured, and fluid is then jetted through the nozzle against the formation at a pressure sufficient to form a cavity, or slot, therein and fracture the formation by stagnation pressure in the cavity. In certain instances, the jetted fluid comprising particles may be used to perforate a casing lining the well bore. Sand or some other particulate is often added to the jetted fluid to improve the cutting efficiency; however, the presence of the sand after the job is complete has been known to cause sticking in the well bore or clogging of the formation pores, thus, restricting hydrocarbon production. Additionally, the sand remaining down hole may pose further problems, inter alia, by damaging production equipment if the sand is produced from the well.

### SUMMARY OF THE INVENTION

The present invention relates to methods of using jetted fluids. More specifically, the present invention relates to methods of using jetted fluids comprising degradable particles in cleaning and cutting operations.

One embodiment of the present invention provides a method of cleaning a surface comprising the step of jetting against a surface to be cleaned a cleaning fluid comprising a base fluid and degradable particles.

Another embodiment of the present invention provides a method of cutting a surface comprising the step of jetting against a surface to be cut a cutting fluid comprising a base fluid and degradable particles.

Still another embodiment of the present invention provides a method of stimulating a formation comprising the step of jetting a cutting fluid comprising a base fluid and degradable particles against a surface in a subterranean formation so as to cut into the formation.

The features and advantages of the present invention will be readily apparent to those skilled in the art upon a reading of the description of the preferred embodiments that follows.

### DESCRIPTION OF PREFERRED EMBODIMENTS

The present invention relates to methods of using jetted fluids. More specifically, the present invention relates to methods of using jetted fluids comprising a base fluid and degradable particles in cleaning and cutting operations.

Some embodiments of the present invention provide methods of cleaning a surface comprising the step of jetting a cleaning fluid against the surface to be cleaned wherein the cleaning fluid comprises a base fluid and degradable particles. Other embodiments of the present invention provide methods of cutting a surface comprising the step of jetting a cutting fluid against the surface to be cut wherein the cutting fluid comprises a base fluid and degradable particles. The term “particle” as used herein is intended to include material particles having the physical shape of platelets, shavings, flakes, ribbons, rods, strips, spheroids, toroids, pellets, tablets, or any other physical shape.

Degradable particles suitable for use in the present invention are those materials capable of undergoing an irreversible degradation during or after use. The term “irreversible” as used herein means that the degradable material, once degraded, should not naturally or sua sponte recrystallize, reconstitute, or resolidify. The terms “degradation” and “degradable” refer to both the relatively extreme cases of hydrolytic degradation that the degradable material may undergo, i.e., heterogeneous (or bulk erosion) and homogeneous (or surface erosion), and any stage of degradation in between these two. This degradation can be a result of, inter alia, a chemical or thermal reaction or a reaction induced by radiation.

Examples of degradable particles that may be used in conjunction with the present invention include but are not limited to materials that degrade in the presence of water (such as degradable polymers that undergo hydrolysis and dehydrated salts that hydrate) and materials that degrade when subjected to treatment temperatures (such as degradable polymers compounded with a hydrate organic or inorganic compound capable of releasing water at the treatment temperature). One of ordinary skill in the art with the benefit of this disclosure will be able to determine the appropriate degradable particle to achieve the desired degradation time, degradation by-products, and the like.

Suitable examples of degradable particle that may be used in accordance with the present invention include but are not limited to those described in the publication of Advances in Polymer Science, Vol. 157 entitled “Degradable Aliphatic Polyesters” edited by A. C. Albertsson. Specific examples of suitable polymers include polysaccharides; chitins; chitosans; proteins; aliphatic polyesters; poly(lactides); poly(glycolides); poly(ε-caprolactones); poly(hydroxybutyrates); poly(anhydrides); aliphatic polycarbonates; poly(orthoesters); poly(amino acids); poly(ethylene oxides); polyphosphazenes; polyvinyl alcohol; poly ethylene oxide; poly(adipic anhydride), poly(suberic anhydride), poly(sebacic anhydride), poly(dodecanedioic anhydride), poly(maleic anhydride), poly(benzoic anhydride); and combinations thereof. Poly(lactides) are preferred degradable polymers for the compositions and methods of the present invention.

Suitable examples of dehydrated salts include, but are not limited to, particulate solid anhydrous borate materials. Specific examples of particulate solid anhydrous borate materials that may be used include, but are not limited to, anhydrous sodium tetraborate (also known as anhydrous borax), and anhydrous boric acid. Such anhydrous borate materials are only slightly soluble in water. However, with time and heat, the anhydrous borate materials react with the surrounding aqueous fluid and are hydrated. The resulting hydrated borate materials are highly soluble in water as compared to anhydrous borate materials and as a result degrade in the aqueous fluid. In some instances, the total time required for the anhydrous borate materials to degrade in an aqueous fluid is in the range of from about 8 hours to about 72 hours depending upon temperature.

In the case where the jetted fluid comprising degradable materials is non-aqueous, and yet the chosen degradable material requires the presence of water to degrade, compounds may be added to either the degradable particle itself or to the cleaning or cutting fluid to produce the necessary water. Suitable such compounds include hydrated organic or inorganic compounds. Such materials include, but are not limited to, hydrates of organic acids or their salts, such as sodium acetate trihydrate, L-tartaric acid disodium salt dihydrate, sodium citrate dihydrate; hydrates of inorganic acids or their salts, such as sodium tetraborate decahydrate, sodium hydrogen phosphate heptahydrate, sodium phosphate dodecahydrate; amylose; starch-based polymers; and cellulose-based hydrophilic polymers. These compounds, with time and heat, dehydrate to release water.

Blends of degradable materials are also suitable for use in the present invention. One example of a suitable blend of materials is a mixture of poly(lactic acid) and sodium borate where the mixing of an acid and a base could result in a neutral solution where this is desirable. Another example would include a blend of poly(lactic acid) and boric oxide. Another example would include a blend of a hydrated organic or inorganic compound with a degradable material, such as a degradable polymer or a dehydrated salt, wherein the hydrated organic or inorganic compound releases water sufficient to degrade the degradable material.

In choosing the appropriate degradable particle, one should consider the degradation products that will result. These degradation products should not adversely affect other operations or components. The choice of degradable material also can depend, at least in part, on the conditions under which the particle will be used, e.g., cleaning application temperature. For instance, lactides have been found to be suitable for lower temperature applications, including those within the range of 60° F. to 150° F., and poly(lactides) have been found to be suitable for application temperatures above this range. Some stereoisomers of poly(lactide) or mixtures of such stereoisomers may be suitable for even higher temperature applications. Dehydrated salts may also be suitable for higher temperature applications.

A preferable result is achieved if the degradable particle degrades slowly over time as opposed to instantaneously. The degradable particle must be able to maintain a solid form for at least a portion of the cleaning or cutting application to produce the desired abrasive effect.

The degradable particles generally should have a particle size that is suitable for use in jetting tools that may be used in the methods of the present invention. In an exemplary embodiment, the degradable particles should have an average particle size in the range of from about 400 mesh to about 8 mesh. In other exemplary embodiments, the degradable particles should have an average particle size in the range of from about 100 mesh to about 40 mesh.

In the cleaning embodiments of the present invention, the degradable particles are included in cleaning fluids wherein the cleaning fluids generally comprise a base fluid and the degradable particles. Additional additives suitable for use in cleaning operations may be included in the cleaning fluids as desired.

The base fluid component of the cleaning fluids of the present invention may be aqueous-based, nonaqueous-based, or mixtures thereof. Where the base fluid is aqueous-based, the water used can be fresh water, salt water (e.g., water containing one or more salts dissolved therein), brine, or seawater. Generally, the water can be from any source provided that it does not contain an excess of compounds that may adversely affect other components in the fluid. Where the base fluid is nonaqueous-based, examples of suitable nonaqueous materials include, but are not limited to, mineral oils, synthetic oils, esters, and the like. In certain embodiments where the base fluid is non-aqueous-based, the degradable particle may be a blend of a degradable material, such as a degradable polymer or a dehydrated salt, with a hydrated organic or inorganic compound, wherein the hydrated organic or inorganic compound releases water sufficient to degrade the degradable material. One of ordinary skill in the art with the benefit of this disclosure will recognize which type of base fluid is appropriate for a particular application.

The cleaning methods of the present invention generally comprise jetting a cleaning fluid against a surface to be cleaned wherein the cleaning fluid comprises degradable particles. Among other things, the presence of the degradable particles within the cleaning fluid may improve the cleaning efficiency by acting as an abrasive cleaning agent. The cleaning fluids may be jetted by use of any number of suitable methods. For example, a jetting tool comprising at least one fluid jet-forming nozzle may be placed adjacent to the surface to be cleaned, and the cleaning fluid may then be jetted through the nozzle against the surface to be cleaned at a pressure sufficient to have the desired cleaning effect. In an exemplary embodiment, the cleaning fluid may be jetted at a jet pressure differential below about 2,000 psi. However, one should recognize that in the cleaning methods of the present invention it may not be desirable to cut the surface that is being cleaned. In some embodiments, to avoid cutting the surface, the jetting tool may be placed so that the fluid nozzles are aligned at substantially less than a 90° angle with the surface, such as from about 30° to about 70°. When placed at an angle, the degradable particles may have a tendency to bounce off the surface being cleaned, reducing the cutting effect of the degradable particles.

In the cleaning embodiments of the present invention, the degradable particles may further comprise additional additives that may be suitable for use in cleaning operations, including, but not limited to, scale inhibitors, chelating agents, corrosion inhibitors, and clay stabilizers. One of ordinary skill in the art with the benefit of this disclosure will recognize when a particular additive is suitable for a chosen application.

The degradable particles should generally be included in the cleaning fluids of the present invention in an amount sufficient to achieve the desired cleaning efficiency. In an exemplary embodiment, the degradable particles should be included in the cleaning fluids of the present invention in an amount in the range of from about 0.1 to about 1 pound per gallon of the base fluid.

In the cutting embodiments of the present invention, the cutting fluid comprises a base fluid such as those described above and the degradable particles such as those described above. Additional additives suitable for use in cutting operations may be included in the cutting fluids as desired.

The degradable particles suitable for use in the cutting fluids are described above. It should be understood that, in the cutting embodiments of the present invention, the properties of the degradable materials used in the degradable particles may be tailored, inter alia, to improve the cutting efficiency of the cutting operation. One way to tailor the particles is to include hardeners therein to improve the cutting efficiency. Such hardeners may be incorporated by mixing a degradable material with a hardener material and then forming composite particles comprising hardener and degradable materials from that mixture. Examples of suitable hardeners include, but are not limited to, colemanite, sodium borate, marble, and magnesium oxide. In an exemplary embodiment, the degradable particles comprise a poly(lactic) acid and sodium borate, wherein upon degradation the resultant acid may effectively dissolve the hardener. Another potential embodiment involves the encapsulation of a degradable material in a shell formed of hardener using known particulate encapsulation methods. Such a shell material may comprise resins such as epoxy, ceramics such as magnesium potassium phosphate hexahydrate, cements such as Portland cement, or a combination thereof. In such embodiments, the hardened shell may shatter when it is forcefully jetted against the surface being cut, releasing the degradable material to the environment. In certain other embodiments, these hardeners may be added independently to the cutting fluid rather than incorporated into the degradable material to improve the cutting efficiency of the cutting fluid, wherein the cutting fluid comprises a base fluid, degradable particles, and a hardener.

The degradable particles should generally be included in the cutting fluids of the present invention, inter alia, in an amount sufficient to achieve the desired cutting efficiency. In an exemplary embodiment, the degradable particles should be included in the cutting fluids of the present invention in an amount in the range of from about 0.1 to about 1 pounds per gallon of the base fluid.

The cutting methods of the present invention generally comprise jetting a cutting fluid against a surface to be cut wherein the cutting fluid comprises degradable particles. Among other things, the presence of the degradable particles within the cutting fluids should improve the cutting efficiency of the jetted cutting fluid. The cutting methods of the present invention may be used to cut a wide variety of materials, such as steel, sheet metal, rock, slabs, engraving materials (e.g., steel, sheet metal, or granite). In certain embodiments, the cutting methods may be used in subterranean operations to cut a wide variety of materials, such as formation rock, casing, cement, and the like.

The cutting fluid may be jetted using any of a variety of suitable jetting methods. For example, in a typical operation (e.g., hydrajetting) a jetting tool comprising at least one fluid jet-forming nozzle may be placed adjacent to the surface to be cut, and the cutting fluid is then jetted through the nozzle against the surface at a pressure sufficient to cut the surface. In certain embodiments, the cutting methods may be used to form at least one perforation in a casing lining a well bore. In another embodiment, the cutting fluid may be jetted against a formation at a sufficient pressure to cut the formation (e.g., to form a cavity or slot therein) and to fracture the formation by stagnation pressure in the cut. In some embodiments, the jetted fluid may be jetted against a formation through a perforation in a casing lining a well bore. In another embodiment, the nozzles may remain stationary, or the nozzles may be moved at a desired speed to cut the surface. Suitable hydrajetting tools for use in the methods of the present invention are described in U.S. Pat. Nos. 5,249,628; 5,325,923; 5,396,957; and 5,499,678, the relevant disclosures of which are incorporated herein by reference.

The cutting fluid may be jetted at a pressure and an angle suitable to achieve the desired cutting effect. In an exemplary embodiment, the cutting fluid may be jetted at a jetting differential pressure in the range of, but not limited to, 1,500 psi to about 10,000 psi. In another exemplary embodiment, the fluid is jetted against the fluid to be cleaned at an angle between 70 and 90 degrees.

Therefore, the present invention is well adapted to carry out the objects and attain the ends and advantages mentioned as well as those that are inherent therein. While numerous changes may be made by those skilled in the art, such changes are encompassed within the spirit and scope of this invention as defined by the appended claims.

1. A method of cleaning a surface comprising the step of jetting against a surface to be cleaned, a cleaning fluid comprising a liquid base fluid and degradable particles wherein the degradable particles act as an abrasive agent and wherein the degradable particles have an average particle size greater than 300 μm.

2. The method of claim 1 wherein the base fluid comprises an aqueous fluid.

3. The method of claim 1 wherein the base fluid comprises fresh water, salt water, brine, seawater, or a combination thereof.

4. (canceled)

5. The method of claim 1 wherein the degradable particle is a solid particle comprising a polysaccharide; a chitin; a chitosan; a protein; an aliphatic polyester; a poly(lactide); a poly(glycolide); a poly(ε-caprolactone); a poly(hydroxybutyrate); a poly(anhydride); an aliphatic polycarbonate; a poly(orthoester); a poly(amino acid); a poly(ethylene oxide); a polyphosphazene; a polyvinyl alcohol; poly(adipic anhydride); poly(suberic anhydride); poly(sebacic anhydride); poly(dodecanedioic anhydride); poly(maleic anhydride); poly(benzoic anhydride); or a combination thereof.

6. The method of claim 1 wherein the degradable particle is a solid particle comprising a dehydrated salt.

7. The method of claim 1 wherein the degradable particle is a solid particle comprising a solid anhydrous borate, anhydrous sodium tetraborate, anhydrous boric acid, or a combination thereof.

8. The method of claim 1 wherein the base fluid comprises a nonaqueous fluid.

9. The method of claim 8 wherein the nonaqueous base fluid comprises a mineral oil, a synthetic oil, an ester, or a combination thereof.

10. The method of claim 8 wherein the cleaning fluid further comprises a compound that will produce water upon degradation.

11. The method of claim 8 wherein the degradable particle further comprises a compound that will produce water upon degradation.

12. The method of claim 10 wherein the compound that will produce water upon degradation comprises a hydrate of an organic acid; a hydrate of an organic acid salt; a hydrate of an inorganic acid; a hydrate of an inorganic acid salt; a starch-based polymer; a cellulose-based hydrophilic polymer; or a combination thereof.

13. The method of claim 11 wherein the compound that will produce water upon degradation comprises a hydrate of an organic acid; a hydrate of an organic acid salt; a hydrate of an inorganic acid; a hydrate of an inorganic acid salt; a starch-based polymer; a cellulose-based hydrophilic polymer; or a combination thereof.

14. The method of claim 1 wherein the degradable particles have an average particle size of from about 400 mesh to about 8 mesh.

15. The method of claim 1 wherein the cleaning fluid is jetted at the surface to be cleaned at a jet pressure differential of below about 2,000 psi.

16. The method of claim 1 wherein the cleaning fluid is jetted at the surface to be cleaned at an angle from about 30 degrees to about 70 degrees relative to the surface to be cleaned.

17. The method of claim 1 wherein the cleaning fluid further comprises a scale inhibitor, a chelating agent, a corrosion inhibitor, a clay stabilizer, or a combination thereof.

18. The method of claim 1 wherein the cleaning fluid comprises from about 0.1 to about 1 pound of degradable particles per gallon of base fluid.

19-59. (canceled)

60. A method of cleaning a surface comprising the step of jetting against a surface to be cleaned, a cleaning fluid comprising a liquid base fluid and degradable particles wherein the degradable particles act as an abrasive agent and wherein the degradable particles comprise a degradable polymer.

61. The method of claim 60 wherein the wherein the degradable polymer is a solid particle comprising a polysaccharide; a chitin; a chitosan; a protein; an aliphatic polyester; a poly(lactide); a poly(glycolide); a poly(ε-caprolactone); a poly(hydroxybutyrate); a poly(anhydride); an aliphatic polycarbonate; a poly(orthoester); a poly(amino acid); a poly(ethylene oxide); a polyphosphazene; a polyvinyl alcohol; poly(adipic anhydride); poly(suberic anhydride); poly(sebacic anhydride); poly(dodecanedioic anhydride); poly(maleic anhydride); poly(benzoic anhydride); or a combination thereof.

62. The method of claim 60 wherein the degradable particles have an average particle size greater than 300 μm.
